(19) United States
(12) Patent Application Publication
(10) Pub. No.: US 2011/0203025 A1
(43) Pub. Date: Aug. 25, 2011

(54) LAMINATED FABRIC

(76) Inventor: Duncan Cannon, Lancashire (GB)

(21) Appl. No.: 13/122,543

(22) PCT Filed: Sep. 29, 2009
(86) PCT No.: PCT/GB09/02298

§ 371 Date: Apr. 4, 2011

(30) Foreign Application Priority Data
Oct. 2, 2008 (GB) 0818003.6
Feb. 25, 2009 (GB) 0903118.8
Apr. 24, 2009 (GB) 0907054.1

(51) Int. Cl. B63C 11/04; B32B 5/26; B32B 25/10; B32B 27/34; B32B 27/36; B60J 7/00; B32B 37/18

(52) U.S. Cl. 2/2.15; 428/221; 296/211; 156/278

(57) ABSTRACT

A waterproof and airtight laminated fabric is disclosed. The fabric is suitable for the manufacture of dry suits, or for the manufacture of a convertible car soft top hood. A dry suit and a car hood made from the fabric, and methods of manufacturing the fabric, are also disclosed.

### RELATED APPLICATION AND CLAIM OF PRIORITY

This patent document claims priority to International Patent Application Number PCT/GB2009/002298, filed Sep. 29, 2009, which in turn claims priority to: (i) Great Britain Patent Application Number 0818003.6, filed Oct. 2, 2008; (ii) Great Britain Patent Application Number 0903118.8, filed Feb. 25, 2009; and (iii) Great Britain Patent Application Number 0907054.1, filed Apr. 24, 2009.

### BACKGROUND

Dry suits are worn by divers and others who work or undertake recreational activities in or near cold water. Dry suits are distinguished from wet suits in that they aim to prevent water from entering within the suit. As such, the main part of a dry suit is a waterproof shell.

Membrane dry suits are known in the art and are made from thin materials and so of themselves provide little thermal insulation. They are commonly made of vulcanized rubber or laminated layers of nylon and butyl rubber. To stay warm in a membrane dry suit, the user must wear an often cumbersome insulating under-suit, typically made with wool, polyester or other synthetic fibre batting material.

There is a consistent requirement to improve the insulating properties of membrane dry suits so as to enable the wearer to be comfortably immersed for longer periods of time in colder water.

A convertible car or automobile is a type of car with a roof which can retract and fold away, converting the car from an enclosed car to an open-air car. The roof or hood is typically affixed to the car and comprises a hinged arrangement so that the hood can fold away, either into a recess behind the back seat or into the boot or trunk of the car. The hood may be folded away manually or automatically. The interior of a convertible car is generally very cold in the cold weather, requiring a powerful in car heating system to make them comfortable.

### SUMMARY

According to the present invention, there is provided a laminated fabric coated with a single reflective layer for reflecting thermal radiation inwardly from a inner layer of the fabric, wherein the fabric comprises an outer layer of durable synthetic fabric and an inner layer of synthetic fabric laminated together by an intermediate layer of a rubber composition, wherein the inner surface of the inner layer is coated by deposition with a thin layer of reflective metal, for example a thin layer of aluminum.

Using a single reflective layer positioned on the inner surface of the inner layer of the laminated fabric provides optimized thermal insulation to an individual located inside of the inner layer, while minimizing the cost of manufacturing the fabric as only a single reflective layer is required.

The laminated fabric according to the present invention may be suitable for the manufacture of dry suits. In this case, the outer fabric layer may be a durable nylon fabric, such as woven from nylon 6, 6, or Cordura™ or may be a high tenacity and/or a ripstop nylon fabric or may be a durable polyester fabric. The inner fabric layer may be a polyester or a nylon fabric. The fabric may be a woven fabric. The intermediate layer may be a vulcanized butyl rubber composition.

There is also provided a membrane dry suit made from a fabric according to the present invention wherein the single deposited layer of reflective metal comprises the inner face of the dry suit. When the fabric is used in the manufacture of a membrane dry suit, the addition of the single deposited layer of reflective metal reflects radiant thermal energy back towards the wearer of the dry suit so as to improve the heat retaining properties of the membrane dry suit. In addition, the reflective metal layer is highly visible to radar detection and so can be used to locate a wearer of the suit if lost at sea.

In addition the use of the single thin deposited layer of reflective metal, in particular aluminum has the technical advantage of protecting the nylon/polyester fabric layers against derogation of the bond strength to the intermediate butyl rubber layer by perspiration, water, salt and other influences. Other inherent properties of the laminated fabric with the inner single metal coated layer are anti-static and anti-friction so that a dry suit made from the fabric is quick to don and abrasion resistance.

The butyl rubber composition may have thermal heat reflective particles suspended within it, for example particles of titanium dioxide. The reflective particles may also assist in reflecting radiant thermal energy back towards the wearer of the suit, and so improves the heat retaining properties of the membrane dry suit.

The layer of butyl rubber composition may comprise a multi-proofed layer of anti-swell chloro butyl rubber, so as to make the fabric water proof and airtight.

The laminated fabric according to the present invention may be suitable for the manufacture of soft-top car hoods. In this case, the outer fabric layer may be a durable acrylic fabric and the inner fabric layer may be a polyester fabric. The fabrics may be woven fabrics. The intermediate layer may be a vulcanized polychloroprene rubber composition.

There is also provided a soft top car hood made from a fabric according to the present invention wherein the single deposited layer of reflective metal comprises the inner face of the car hood facing the interior of the car. When the fabric is used in the manufacture of a soft-top car hood, the addition of the single deposited layer of reflective metal reflects radiant thermal energy back towards the interior of the car. As only a single reflective layer is used additional costs are minimized Thus, the thermal insulating properties of the car hood reduce the amount of work required by the car's heating system to keep the car interior at a comfortable temperature.

The polychloroprene rubber composition may have thermal heat reflective particles suspended within it, for example particles of titanium dioxide. The reflective particles may also assist in reflecting radiant thermal energy back towards the interior of the car, and so improves the heat retaining properties of the car hood.

There is also provided a method of manufacturing a fabric according to the present invention, comprising the steps of: coating an inner side of the inner fabric layer with a thin deposited layer of reflective metal; applying at least one layer of a rubber coating solution to an inner side of the outer fabric layer and drying each layer before application of the next layer; applying at least one layer of a rubber coating solution to an outer side of the inner fabric layer and drying each layer before application of the next layer; laminating the rubber coated sides of the inner and outer layer together, for example, by passing them through a pair of nip rollers; and vulcanizing the resulting laminated fabric by heating. The method provides an efficient way of manufacturing a fabric with enhanced reflective thermal energy retention suitable for the manufacture of dry suits and car soft-top hoods. The fabric also enables gluing and taping to the metalized inner face of the fabric as may be required in dry suit manufacture.

The thin deposited layer of reflective metal may be applied to the inner face of the inner layer of fabric by physical vapor deposition. Typically, the coating weight will be in the range of 1 to 10 g/m².

A first layer of the rubber coating solution applied to the inner and outer fabric layers may additionally comprise a polyisocyanate group containing component so as to promote adhesion between the butyl rubber and the fabric layers.

The step of drying may comprise the step of heating the fabric to increase the speed of solvent removal. In this case, the last applied rubber layer on at least one of the inner or outer fabric layers may be dried immediately before the laminating step. In this way any residual solvent and the raised temperature of the or each fabric layer due to the immediately preceding drying step aids adhesion in the lamination step.

### BRIEF DESCRIPTION OF THE DRAWINGS

The invention will now be described by way of example only and with reference to the accompanying schematic drawings, wherein:

FIG. 1 shows a transverse cross-sectional view of a sheet of laminated fabric according to the present invention;

FIG. 2 shows a cross-sectional view of a dry suit made from the fabric of FIG. 1 and an insulating undersuit around an outline of a body of a wearer;

FIG. 3 shows a cross-sectional close up view of region A through the dry suit and undersuit of FIG. 2;

FIG. 4 shows a flow diagram of the process of making the fabric of FIGS. 1; and

FIG. 5 shows the knife over roller coating technique and the lamination technique using a pair of nip rollers which are used in the making of the fabric of FIG. 1.

### DETAILED DESCRIPTION

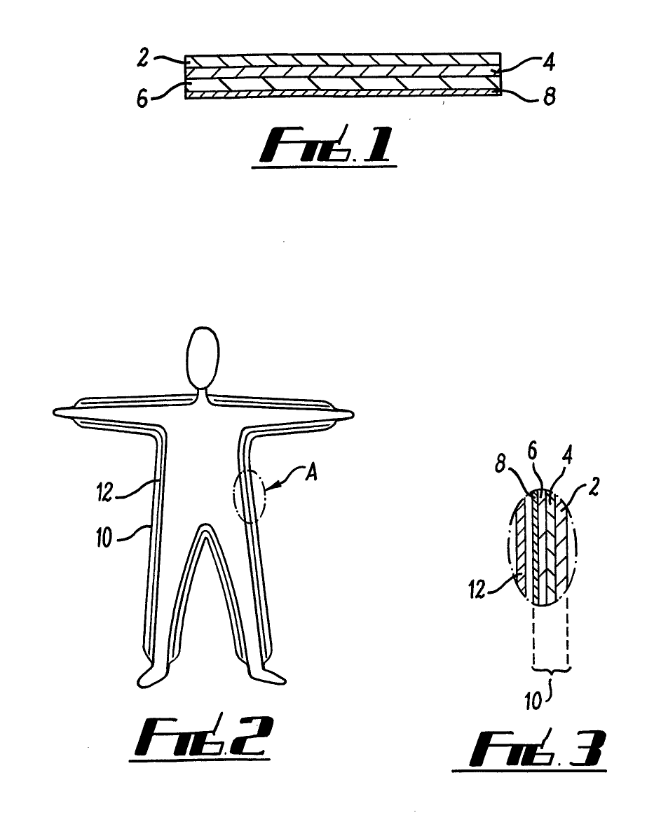

In a first example, as shown in FIG. 1, the laminated fabric comprises an outer layer (2) of a durable nylon or polyester fabric, which is resistant to abrasions, tears and scuffs. The fabric also comprises an inner layer (6) of a polyester or nylon fabric. The outer (2) and inner (6) fabric layers are laminated together by an intermediate layer (4) of a butyl rubber composition. Also, the inner face of the inner layer (6) is coated with a reflective coating (8) of a metal composition, for example by physical vapor deposition or by chemical vapor deposition. The reflective metal coating (8) may be a coating of aluminum. The laminated fabric of FIG. 1 is fully waterproof and airtight and is suitable for use in the production of a membrane dry suit for the diving market.

The fabric of FIG. 1, when used in the production of a dry suit has the outer fabric layer (2) outermost and the inner fabric layer (6) innermost, with the metal coating (8) on the inwardly facing face of the inner fabric layer. The metal coating (8) reflects thermal energy from a wearer's body back towards the wearer and so enhances the heat retaining properties of the dry suit. The metal coating (8) also has the advantage of making the dry suit visible to radar detector devices, making it easier to locate a wearer of the dry suit should they become lost at sea.

The outer fabric layer (2) may be made from a fabric woven from nylon 6,6 (also known as Cordura™) and manufactured by Invista, a wholly owned subsidiary of Kock Industries Inc. Alternative fabrics include high tenacity nylon with a nominal mass within the range 60 to 240 g/m², typically around 60 g/m², high tenacity rip stop nylon with a nominal mass within the range 50 to 100 g/m² and a denier within the range 45 to 75 denier, for example, 75 g/m² and 70×70 denier, 60 g/m² and 50 denier, 190 g/m² and 470 denier and polyester having a nominal mass within the range 70 to 250 g/m², typically around 200 g/m².

The inner fabric layer (6) is typically lighter and less durable then the outer fabric layer and may be made from polyester fabric with a nominal mass within the range 70 to 250 g/m², typically around 90 g/m² or high tenacity nylon fabric with a nominal mass within the range 60 to 200 g/m², typically around 75 g/m².

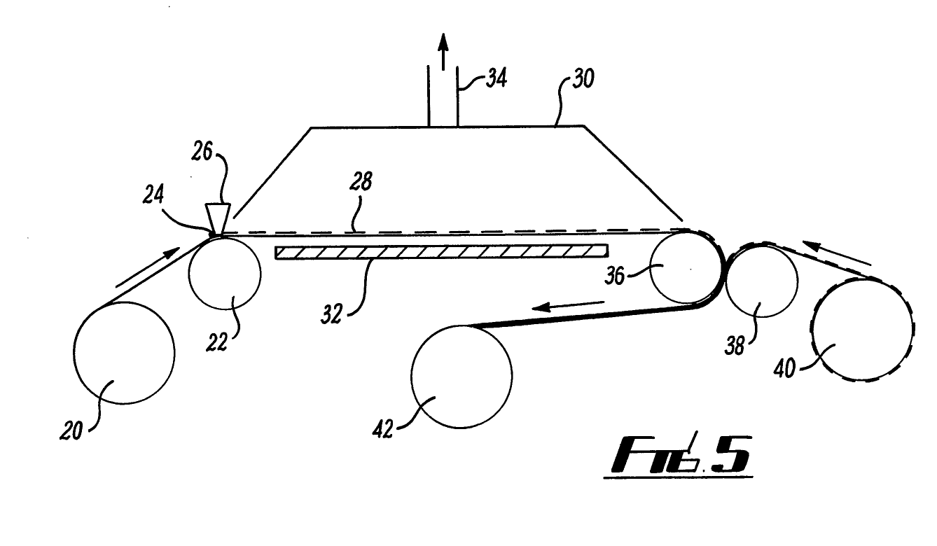

To manufacture the fabric of FIG. 1, firstly the polyester fabric of the inner layer (6) is coated on one side with a reflective metal coating, for example by physical vapor deposition (PVD) or by chemical vapor deposition (CVD) [Box i of FIG. 4]. Both methods of metal coating deposition are known in the art. Physical vapor deposition is a method of vacuum deposition in which a thin layer is deposited onto a substrate by the condensation of the vaporized form of the metal onto the substrate.

The non-metal coated side of the polyester fabric of the inner layer (6) is coated with several layers of a butyl rubber composition, which will form part of the intermediate layer (4). The butyl rubber composition is an anti-swell halogenated butyl rubber, in particular chlorinated butyl rubber. The composition may also include a compound to assist the heat reflective properties of the intermediate layer (4), for example titanium dioxide. The chloro butyl rubber and metal oxide are granulated and then dissolved in a solvent, such as toluene (methyl benzene) or MEK (methyl ethyl ketone) to form a coating solution. The first layer of coating solution applied to the non-metal coated side of the polyester fabric additionally contains an additive to promote adhesion to the polyester fabric, such as a compound solution including a polyisocyanate group. The first layer of coating is applied to the non-metal coated layer of the polyester fabric by a knife over a roller technique [Box ii of FIG. 4] and is then dried over a heated chest to remove the solvent [Box iii of FIG. 4]. Then several additional layers of coating solution (without the polyisocyanate) are applied over the previous layer [Box iv of FIG. 4], with each layer dried before the next is applied [Box v of FIG. 4]. This generates a multi-proofed layer of anti-swell chloro butyl rubber impregnated with particles of titanium dioxide.

The inner side of the outer nylon layer (2) is coated in the same way [Boxes vi to ix of FIG. 4].

The knife over a roller coating technique is shown on the left hand side of FIG. 5. The fabric, or the fabric with one or more layers of the dried butyl rubber composition coating already applied, is held on a roller (20) with the surface to be coated outermost. The surface to be coated might be the inner side of the outer fabric layer (2), the outer (non-metalized) side of the inner fabric layer (6) or, where one or more coatings are already applied, the last dried butyl rubber layer. The fabric on the roller (20) is fed to a coating application stage comprising a coating knife (26), roller (22) and coating solution feed (24). The fabric from the roller (20) passes between the roller (22) and the coating knife (26). The coating solution is applied to the upper side of the fabric by the coating solution feed (24) and the upper coated surface of the fabric then passes over the roller (22), beneath the coating knife (26) which controls the thickness of the coating. The fabric then passes from the roller (22) into a solvent extraction chamber (30) and over a heated platoon (32). The fabric is heated on the platoon to cause the solvent to evaporate and solvent and hot air are extracted via a chimney (34) of the extraction chamber, until the coating is dry. The fabric is then stored on a roller ready for the next layer of coating to be applied or ready for lamination.

Then a final layer of the coating solution is applied and with the multi-proofed layers of chloro butyl rubber composition facing each other, the first and second layers (2, 6) are laminated together [Box x of FIG. 4] by passing them through a pair of nip rollers (36,38), with the chloro butyl rubber composition intermediate layer (4) between them.

As shown in FIG. 5, the outer fabric layer (2) is stored on roller (20) with any previous layers of dried butyl rubber coating outermost. The inner fabric layer is stored on roller (40) with any previous layers of dried butyl rubber coating outermost. The outer fabric layer (20) has a further layer of the coating solution applied to it using the knife over roller coating technique described above. The fabric (20) has the coating solution applied to it via the coating solution feed (24) and then passes between the roller (22) and knife (26) into the solvent extraction chamber (30) and over the heated platoon (32) for drying. This outer fabric layer is then passed over the first nip roller (36) and the inner fabric layer (from roller (40)) is passed over a second nip roller (38), with the rubber butyl coated surfaces facing each other to form a laminate fabric which is then stored on roller (42) ready for vulcanization. As the outer fabric layer is fed to the pair of nip rollers (36, 38) directly from the solvent extraction chamber (30), there is some residual solvent in the last applied coating layer and also, this last layer is still hot, which aids adhesion of the two layers of fabric through the pair of nip rollers.

The resulting laminate fabric is then vulcanized by heating, for example in a hot stove or autoclave at a temperature above 275° F. for an hour [Box xi of FIG. 4]. The resulting fabric, as shown in FIG. 1 is then fully waterproof and airtight and ready for use in the manufacture of dry suits.

### EXAMPLE 1

Outer layer dyed Cordura™ 550 denier fabric with a nominal mass of 240 g/m²

Intermediate layer pigmented butyl rubber with a nominal mass of 300 g/m²

Inner layer Polyester fabric with a nominal mass of 90 g/m²

### EXAMPLE 2

Outer layer dyed high tenacity nylon fabric with a nominal mass of 75 g/m²

Intermediate layer pigmented butyl rubber with a nominal mass of 170 g/m²

Inner layer Polyester fabric with a nominal mass of 90 g/m²

### EXAMPLE 3

Outer layer dyed polyester fabric with a nominal mass of 200 g/m²

Intermediate layer pigmented butyl rubber with a nominal mass of 200 g/m²

Inner layer Polyester fabric with a nominal mass of 90 g/m²

### EXAMPLE 4

Outer layer dyed high tenacity rip stop nylon fabric with a nominal mass of 60 g/m²; 50 denier

Intermediate layer pigmented butyl rubber with a nominal mass of 170 g/m²

Inner layer Polyester fabric with a nominal mass of 90 g/m²

### EXAMPLE 5

Outer layer dyed high tenacity ripstop nylon fabric with a nominal mass of 60 g/m²; 50 denier

Intermediate layer pigmented butyl rubber with a nominal mass of 100 g/m²

Inner layer High tenacity nylon fabric with a nominal mass of 75 g/m²

### EXAMPLE 6

Outer layer dyed high tenacity nylon 6,6 fabric with a nominal mass of 190 g/m²; 470 denier

Intermediate layer pigmented butyl rubber with a nominal mass of 200 g/m²

Inner layer Polyester fabric with a nominal mass of 90 g/m²

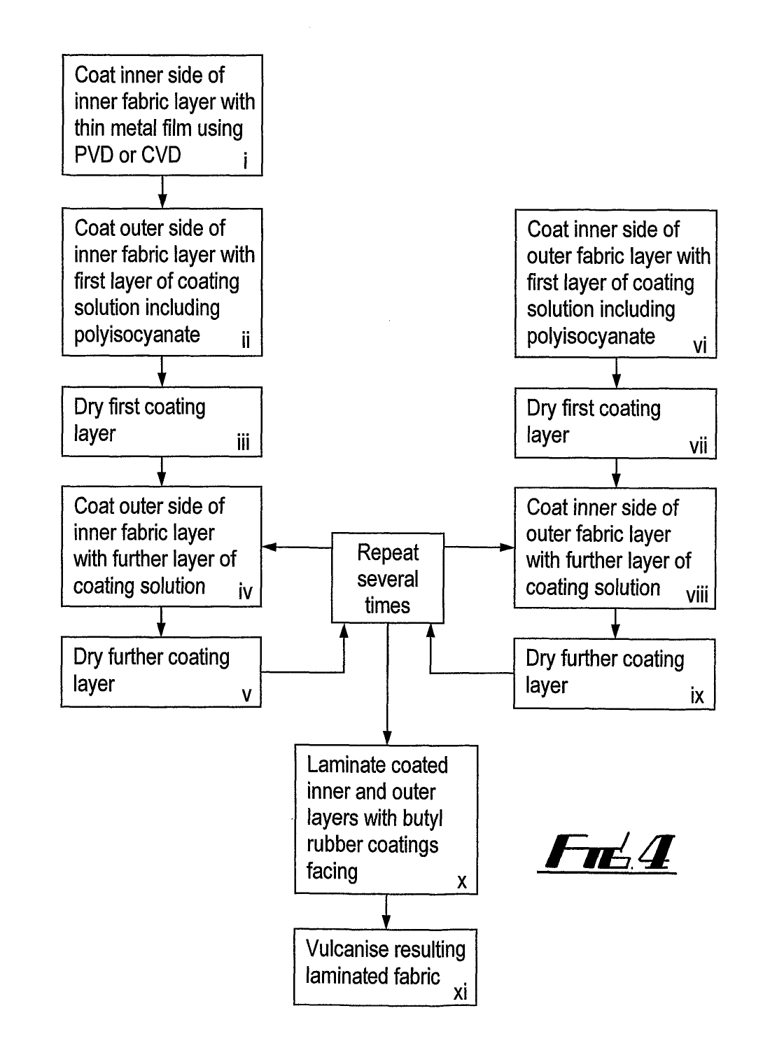

The laminated fabric of FIG. 1 is used to manufacture a membrane dry suit (10) of the type shown in FIG. 2, which is typically worn with an insulating undersuit (12). The undersuit (12) is typically made with wool, polyester or other synthetic fibre batting material. FIG. 3 shows a cross-sectional close up of the region A of FIG. 2, showing the layers of the membrane dry suit (10) and undersuit (12) between the wearer of the suit (to the left hand side) and the outside environment (to the right hand side).

The insulating material of the undersuit (12) lies closest to the user's skin. The membrane dry suit (10) is substantially waterproof and typically has neck and wrist cuffs which seal against a wearer's skin and so prevents the undersuit from being soaked through with water when the user is submerged in cold water. The substantially dry undersuit (12) insulates the wearer and the wearer's body heat generates a layer of warmth in the air around it which the undersuit helps to maintain. The majority of the radiant heat travelling outwardly of the layer of undersuit (12) is reflected back towards the undersuit and the wearer by the reflective metal coating layer (8) on the inside of the drysuit (10). This provides an additional mechanism to a conventional membrane dry suit for preventing heat loss. The fabric of the membrane drysuit (10) also provides some thermal insulation and the titanium dioxide particles suspended in the butyl rubber intermediate layer (4) also help to reflect radiant heat from the wearer back towards the wearer, thus providing additional prevention of heat loss.

Soft top car hoods typically comprise two fabric layers (2, 6) laminated together by an intermediate layer (4) in the same way as is described above for the laminated fabric of FIG. 1. The main difference is that the intermediate layer (6) is a polychloroprene, for example a pigmented polychloroprene. The intermediate fabric layer may have incorporated within it heat reflective particles, such as particles of titanium dioxide, as in described above in relation to the butyl rubber composition of the intermediate layer (4) of the dry suit fabric.

As shown in FIG. 1, the inner face of the inner layer (6) is coated with a reflective coating (8) of a metal composition, for example by physical vapor deposition or by chemical vapor deposition. The reflective metal coating (8) may be a coating of aluminum. When the resulting fabric is used in a convertible car hood, with the coated inner layer facing the interior of the car, the reflective coating (8) will reflect radiant thermal energy back into the car interior so as to reduce the amount of heat required to be generated by the car heating system, in order to keep the car interior at a comfortable temperature. This can make the car more fuel efficient in cold weather and so reduce the carbon footprint of the operation of the car in cold weather conditions.

The inner layer (6) may be 100% polyester cloth, optionally yarn dyed or solution dyed. For example, the polyester cloth may be woven in a dobby pattern from 2/30's warp×1/16's weft ring spun yarn, with a 68×58 count and with sulzer or tuck selvage edges. The fabric may be treated with flora-carbon in order to make it waterproof, but this is not essential as the coating layer (8) will waterproof the fabric. The fabric may have a weight of 210 g/m².

The outer layer (2) may be an acrylic cloth, for example, it may be dope or solution dyed. The acrylic cloth may be a 2/1 twill, 86×34 count, cloth woven from 2/20's ring spun yarn for both the warp and weft, again with sulzer or tuck selvage edges. The fabric may be treated with flora-carbon so as to make it waterproof. The fabric may have a weight of 275 g/m².

A method of manufacture described above in relation to FIGS. 4 and 5 is used to make the laminated car hood fabric. The intermediate layer (4) of polychloroprene (neoprene) polymer is coated onto the inner side of the inner and outer fabric layer to a total coating thickness of 150 g/m² and so when the two coated layers of fabric (2, 6) are laminated together, the intermediate layer has a total coating weight of around 300 g/m².

Thus, a typical weight for the laminated fabric in this example, would be in the range of 685 to 885 g/m².

In this example, the laminated fabric of FIG. 1 is fully waterproof and is suitable for use in the production of a soft-top car hood for a convertible car.

1. A laminated fabric coated with a single reflective layer for reflecting thermal radiation inwardly from an inner layer of the fabric, comprising an outer layer of durable synthetic fabric and an inner layer of synthetic fabric laminated together by an intermediate layer of a rubber composition, wherein the inner surface of the inner layer is coated by deposition with the single layer of reflective metal.

2. A fabric according to claim 1 wherein the rubber composition has thermal heat reflective particles suspended within it.

3. A fabric according to claim 1 wherein the intermediate layer comprises a butyl rubber composition.

4. A fabric according to claim 3 wherein the layer of butyl rubber composition comprises a multi-proofed layer of anti-swell chloro butyl rubber.

5. A fabric according to claim 3 wherein the outer layer is a nylon fabric and the inner layer is a polyester fabric.

6. A fabric according to claim 1 wherein the metal comprises aluminum.

7. A membrane dry suit comprising:
a laminated fabric coated with a single reflective layer for reflecting thermal radiation inwardly from an inner layer of the fabric, comprising an outer layer of durable synthetic fabric and an inner layer of synthetic fabric laminated together by an intermediate layer of a rubber composition, wherein the inner surface of the inner layer is coated by deposition with the single layer of reflective metal;
wherein the thin deposited layer of reflective metal comprises an inwardly facing face of the dry suit.

8. A fabric according to claim 1 wherein the intermediate layer is a polychloroprene rubber composition.

9. A fabric according to claim 8 wherein the outer layer is an acrylic fabric and the inner layer is a polyester fabric.

10. A soft top car hood comprising:
a laminated fabric coated with a single reflective layer for reflecting thermal radiation inwardly from an inner layer of the fabric, comprising an outer layer of durable synthetic fabric and an inner layer of synthetic fabric laminated together by an intermediate layer of a polychloroprene rubber composition, wherein the inner surface of the inner layer is coated by deposition with the single layer of reflective metal;
wherein the thin deposited layer of reflective metal comprises a surface of the car hood configured to face an interior of the a car.

11. A method of manufacturing a fabric, the fabric comprising an inner fabric layer and an outer fabric layer, the method comprising:
coating an inner side of the inner fabric layer with a thin layer of reflective metal by deposition;
applying at least one layer of a rubber coating solution to an inner side of the outer fabric layer and drying each layer before application of a next layer;
applying at least one layer of a rubber coating solution to an outer side of the inner fabric layer and drying each layer before application of a next layer;
laminating the rubber coated sides of the inner and outer fabric layers together to yield a laminated fabric; and
vulcanizing the laminated fabric by heating.

12. A method according to claim 11 wherein the deposition comprises physical vapor deposition.

13. A method according to claim 11 wherein a first layer of the rubber coating solution applied to each of the inner and outer fabric layers additionally comprises a polyisocyanate group to promote adhesion.

14. A method according to claim 11 further comprising drying the last applied rubber layer on at least one of the inner or outer fabric layers immediately before the laminating step.
